(19) United States
(12) Patent Application Publication
(10) Pub. No.: US 2011/0182497 A1
(43) Pub. Date: Jul. 28, 2011

(54) CASCADE STRUCTURE FOR CLASSIFYING OBJECTS IN AN IMAGE

(75) Inventors: Mithun ULIYAR, Bangalore (IN); Venkateswarlu KARNATI, Guntur (IN); Sumit DEY, Bangalore (IN); Smitha GOPU, Warangal (IN)

(73) Assignee: ARICENT INC., George Town (KY)

(21) Appl. No.: 12/692,457

(22) Filed: Jan. 22, 2010

(51) Int. Cl. G06K 9/00; G06K 9/62

(52) U.S. Cl. 382/154; 382/224

(57) ABSTRACT

A cascade object classification structure for classifying one or more objects in an image is provided. The cascade object classification structure includes a plurality of nodes arranged in one or more layers. Each layer includes at least one parent node and each subsequent layer includes at least two child nodes. A parent node in a layer is operatively linked to two child nodes in a subsequent layer. Further, at least one child node in one of the subsequent layers is operatively linked to two or more parent nodes in a preceding layer. Each node includes classifiers for classifying the objects as a positive object and a negative object. The positive object and the negative object classified by the parent node in each layer are further classified by one or more operatively linked child nodes in the subsequent layer.

### FIELD OF THE INVENTION

The present invention, in general, relates to the field of object detection in an image. More particularly, the present Invention provides a cascade Structure for classifying various types of objects in the image in real time.

### BACKGROUND

Face detection in Images and videos is a key component in a wide variety of applications of human-computer interaction, search, security, and surveillance. Recently, the technology has made its way into digital cameras and mobile phones as well. Implementation of face detection technology in these devices facilitates enhanced precision in applications such as Auto Focus and Exposure control, thereby helping the camera to take better images. Further, some of the advanced features in these devices such as Smile shot, Blink shot, Human detection, Face beautification, Red eye reduction, and Face emoticons make use of the face detection as their first step.

Various techniques have been employed over the last couple of decades for obtaining an efficient face detector. The techniques varies from a simple color based method for rough face localization to a structure that make use of complex classifiers like neural networks and support vector machines (SVM). One of the most famous techniques has been AdaBoost algorithm. The AdaBoost algorithm for face detection was proposed by Viola and Jones in “Robust Real-Time Object Detection,” Compaq Cambridge Research Laboratory, Cambridge, Mass., 2001. In the AdaBoost algorithm, Haar features are used as weak classifiers. Each weak classifier of the face detection structure was configured to classify an image sub-window into either face or non-face. To accelerate the face detection speed, Viola and Jones introduced the concepts of an integral image and a cascaded framework. A conventional cascade detection structure 100 proposed by Viola and Jones is illustrated in FIG. 1. Conventional cascade detection structure 100 includes a plurality of nodes such as nodes 102, 104, 106, 108, and 110 arranged in a serial cascade structure. Each node of conventional cascade detection structure 100 includes one or more weak classifiers. Face/non-face detection is performed by using the cascaded framework of successively more complex classifiers which are trained by using the AdaBoost algorithm. As depicted in FIG. 1, the complexity of the classifiers increases from node 102 to node 110. Thus, most of the non-face images will be rejected by the initial stages of the cascade structure. This resulted in real-time face detection structure which runs at about 14 frames per second for a 320×240 image.

However, the face detection technique developed by Viola and Jones primarily deals with frontal faces. Many real-world applications would profit from multi-view detectors that can detect objects with different orientations in 3-Dimension space such as faces looking left or right, faces looking up or down, or faces that are tilted left or right. Further, it is complicated to detect multi-view faces due to the large amount of variation and complexity brought about by the changes in facial appearance, lighting and expression. In case of conventional cascade detection structure 100, it is not feasible to train a single cascade structure for classifying multi-view faces. Hence, to detect multi-view faces using Viola and Jones cascade structure, multiple cascade structures trained with multi-views faces may be employed. However, the use of multiple cascade structures increases the overall computational complexity of the structure.

In the light of the foregoing, for exploiting the synergy between the face detection and pose estimation, there is a well felt need of a cascade structure and method that is capable of classifying faces and objects with different orientations in 3-Dimension space without increasing the computational complexity.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY OF THE INVENTION

In order to address the problem of classifying faces and objects with different orientations, the present invention provides a cascade structure for classifying one or more objects in an image without increasing computational complexity.

In accordance with an embodiment of the present invention, a cascade object classification structure for classifying one or more objects in an image is provided. The cascade object classification structure includes a plurality of nodes that are arranged in one or more layers. Each layer includes at least one parent node and each subsequent layer includes at least two child nodes such that at least one child node in at least one of the subsequent layers is operatively linked to two or more parent nodes in a preceding layer. Each node includes one or more classifiers for classifying the one or more objects as a positive object and a negative object. Each of the positive objects and the negative objects as classified by the at least one parent node in each layer are further classified by one or more operatively linked child nodes in the corresponding subsequent layer.

In accordance with another embodiment of the present invention, a method for classifying one or more objects in an image is provided. The method includes determination of one or more features, associated with the one or more objects, from the image. The one or more objects is evaluated at each node of a plurality of nodes, wherein the plurality of nodes are arranged in one or more layers. In at least one of the one or more evaluations, the node receives the evaluated objects from two or more nodes of a preceding layer. At each node, the one or more objects is classified as a positive object and a negative object based at least in part on the evaluation. At least one of the one or more classifications includes further classifying the positive object and the negative object in the subsequent layer.

Additional features of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a conventional cascade detection structure proposed by Viola and Jones;

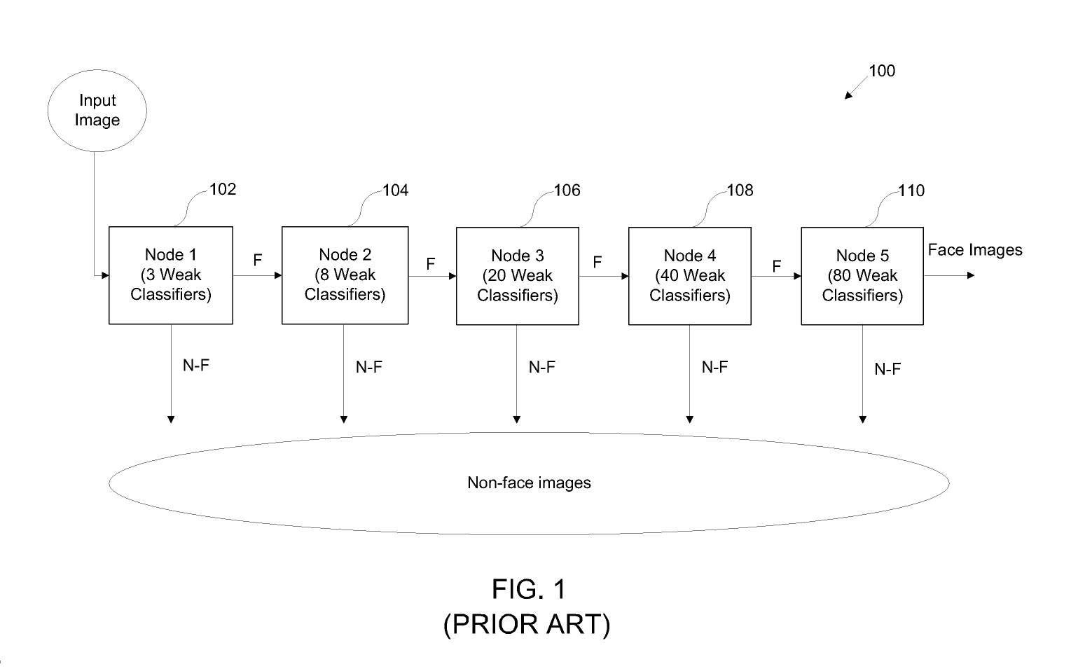

FIG. 2 illustrates a pyramid cascade object classification structure, in accordance with an embodiment of the present invention;

FIG. 3a illustrates a net cascade object classification structure, in accordance with another embodiment of the present invention;

FIG. 3b is a schematic diagram illustrating the training of the net cascade object classification structure for classifying multi-view faces, in accordance with an exemplary embodiment of the present invention;

FIG. 3c is a schematic diagram illustrating the detection of the multi-view faces in the image using the net cascade object classification structure, in accordance with an exemplary embodiment of the present invention;

FIG. 4 is a flow chart depicting a method for classifying one or more objects in an image, in accordance with an embodiment of the present invention;

FIG. 5 illustrates a system that implements the cascade object classification structure as explained with reference to FIGS. 2 and 3, in accordance with an embodiment of the present invention; and

FIG. 6 illustrates an object detection module corresponding to the system (with reference to FIG. 5), in accordance with an embodiment of the present invention.

### DETAILED DESCRIPTION OF THE PREFERRED EMBODIMENTS

Embodiments of the present invention provide a cascade object classification structure and a method for classifying one or more objects in an image. For purposes of the following description, the term “object” may refer to various 3 Dimensional objects such as faces, cars, houses, and so forth. The cascade object classification structure is capable of classifying faces and objects with different orientations in 3-Dimension space without increasing overall computational complexity. Further, the objects classified by a parent node are further classified by one or more operatively linked child nodes, thereby increasing the detection rate of the structure. For example, the cascade object classification structure of the present invention achieves a frontal face detection rate of >95% and a profile face detection rate of ˜85%. Furthermore, one or more classifiers of the structure may be configured to detect various types of objects in the image. Moreover, at least one child node in the structure is operatively linked to two or more parent nodes, thereby reducing the number of nodes in the structure and consequently increasing the detection speed.

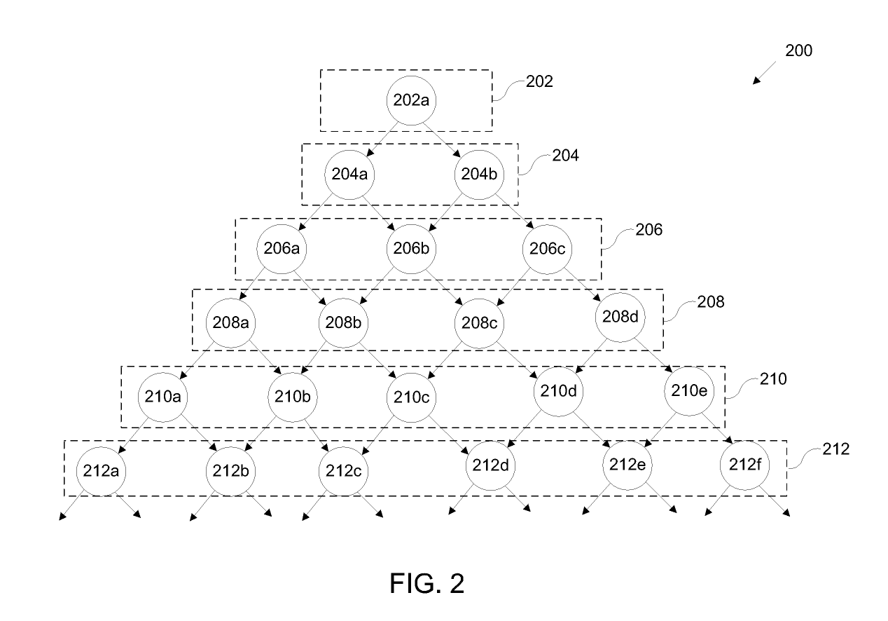

Referring now to FIG. 2, a pyramid cascade object classification structure 200 is shown, in accordance with an embodiment of the present invention. Pyramid cascade object classification structure 200 includes a plurality of nodes such as nodes 202a, 204a-204b, 206a-206c, 208a-208d, 210a-210e, and 212a-212f that are arranged in the form of a pyramid having a plurality of layers such as layers 202, 204, 206, 208, 210, and 212 respectively. As depicted in FIG. 2, pyramid cascade object classification structure 200 includes 6 layers. However, it may be appreciated by a person skilled in the art that, the invention is not limited to 6 layers and may be applicable for a structure having more than 6 layers. For example, in an embodiment, the number of layers in pyramid cascade object classification structure 200 may lie in the range of 6 to 15 layers. Further, the number of layers in structure 200 may vary based on the required efficiency of detection, image processing complexity or computational power. The number of nodes in each layer of the pyramid is proportional to the hierarchy level of the layer in the pyramid. For example, layer 202 is a first layer of the pyramid and includes only one node 202a. Similarly, layer 204 is a second layer of the pyramid and includes two nodes 204a and 204b and so on.

Each node in a layer is operatively linked to two nodes in a subsequent layer. As depicted in FIG. 2, node 202a in layer 202 is operatively linked to nodes 204a and 204b in layer 204; whereas node 204a is operatively linked to nodes 206a and 206b and node 204b is operatively linked to nodes 206b and 206c in layer 206. Each layer includes at least one parent node and each subsequent layer includes at least two child nodes. For example, while working at layer 202 of pyramid cascade object classification structure 200, node 202a represents a parent node and operatively linked nodes 204a and 204b in the corresponding subsequent layer represent child nodes. However, while working at layer 204, node 204a and 204b represent parent nodes and operatively linked nodes 206a, 206b, and 206c in the corresponding subsequent layer represent child nodes. Further, at least one child node in one of the subsequent layers is operatively linked to two or more parent nodes in a preceding layer. For example, as depicted in FIG. 2, nodes 206b, 208b-208c, 210b-210d, and 212b-212e are operatively linked to two parent nodes in the preceding layers 204, 206, 208, and 210 respectively. In each layer of pyramid cascade object classification structure 200, the nodes placed in the beginning of the layer may have low complexity; whereas the nodes placed in the end of the layer may have comparatively high complexity. For example in layer 212, nodes 212a-212c may have low complexity; whereas nodes 212d-212f may have comparatively high complexity.

Each node of the plurality of nodes implements one or more classifiers (not shown). As known in the field of pattern recognition, a classifier is an algorithm that is configured to analyze a received input and to provide a decision based on the analysis. Examples of the classifier include, but are not limited to, AdaBoost classifier, support vector machine (SVM) classifier, and Gaussian mixture model (GMM) classifier. It may be appreciated by a person skilled in the art that, any other classifier known in the art may be used for the purpose of classification at each node.

For classifying one or more objects in an image, the classifiers of the nodes are trained using the supervised mode with an input data in a preliminary or one-time learning phase. The input data includes a set of samples relating to the objects that may be present in the image such as face samples and object samples having different orientations in 3-Dimension space. In various embodiments of the present invention, the classifiers are trained with either similar or different type of the input data. The samples of the input data are termed as positive training samples and negative training samples based on the type of the object that the classifier is configured to classify. For example, to detect the objects such as faces in the image, the input data may include samples of face images with different orientations and non-face images. The face image samples will be termed as the positive training samples and the non-face image samples will be termed as the negative training samples. These samples are then fed into the training code of the classifiers.

During the training, the classifiers compute one or more features from the images relating to the input data. Examples of the features include, but are not limited to, DCT features, Wavelet transformed features, and Haar features. For example, in case of computing Haar features, the classifier may perform simple additions and subtractions corresponding to the intensity values of the pixels in the image. The intensity value of the pixels related to the white and black region is added separately. Thereafter, the sum of the intensity values of the pixels which lie within the black region is subtracted from the sum of the intensity values of the pixels which lie within the white region. The resulting value is known as Haar feature value. It may be appreciated that, the Haar features may correspond to various other features such as dimension co-ordinates, pixel values etc., associated with the images. Thereafter, the computed feature information corresponding to each node is stored in a look up table.

The classifiers are trained layer-by-layer based on the input data (face image samples and non-face image samples) and the corresponding location of the nodes in the pyramid. Further, the training of the classifiers of the operatively linked child nodes also depends on the output provided by the parent nodes in the corresponding preceding layer. For example, the classifiers of node 206a are trained based on the input data, its location in the pyramid and the output provided by its parent node i.e., node 204a in preceding layer 204. However, the classifiers of node 206b are trained based on the input data, its location in the pyramid and the output provided by its two parent nodes i.e., node 204a and node 204b in preceding layer 204. In accordance with an embodiment of the present invention, the classifiers are trained to pass the objects relating to the positive training samples and to reject the objects relating to the negative training samples. Further, the classifiers are trained in such a way that most of the objects relating to the negative training samples are passed through the low complexity nodes of the pyramid; whereas the objects relating to the positive training samples are passed through the high complexity nodes of the pyramid.

While classifying the objects in the image, the classifier evaluates the objects of the image based on selecting features from the computed feature information stored in the look up table and classifies the objects of the image as a positive object and a negative object. In accordance with various embodiments of the present invention, the classifiers of the nodes are configured to detect either similar or different type of the objects such as faces, house, car, and so forth. Moreover, each of the positive objects and the negative objects as classified by each node in a layer are further classified by the operatively linked nodes in the corresponding subsequent layer.

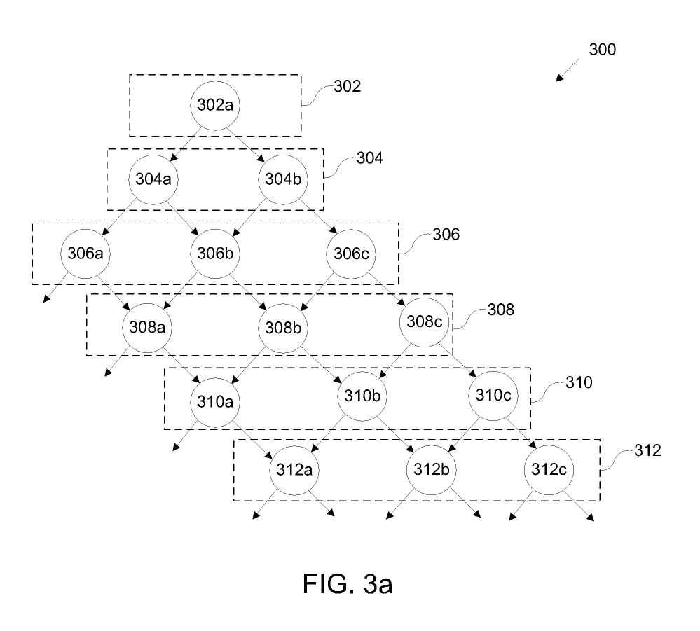

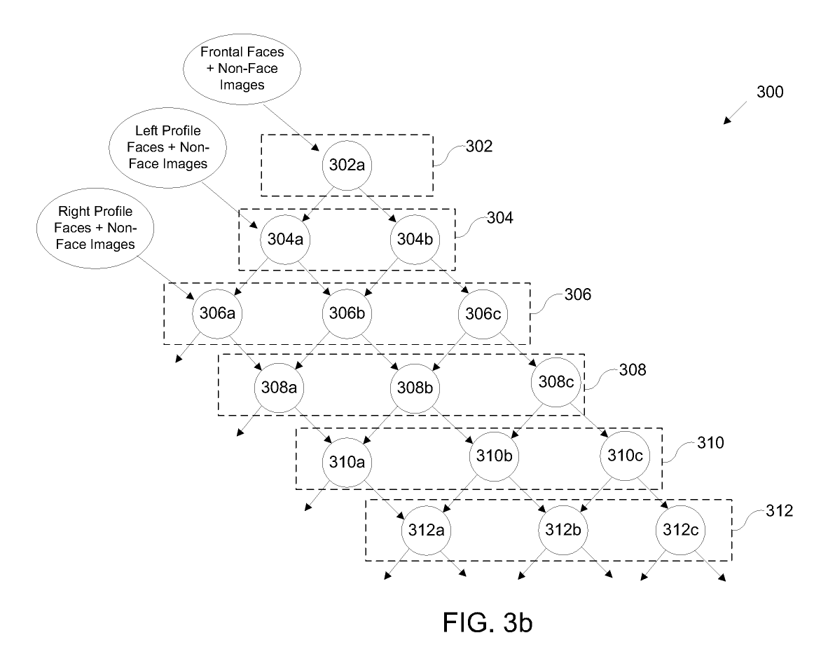

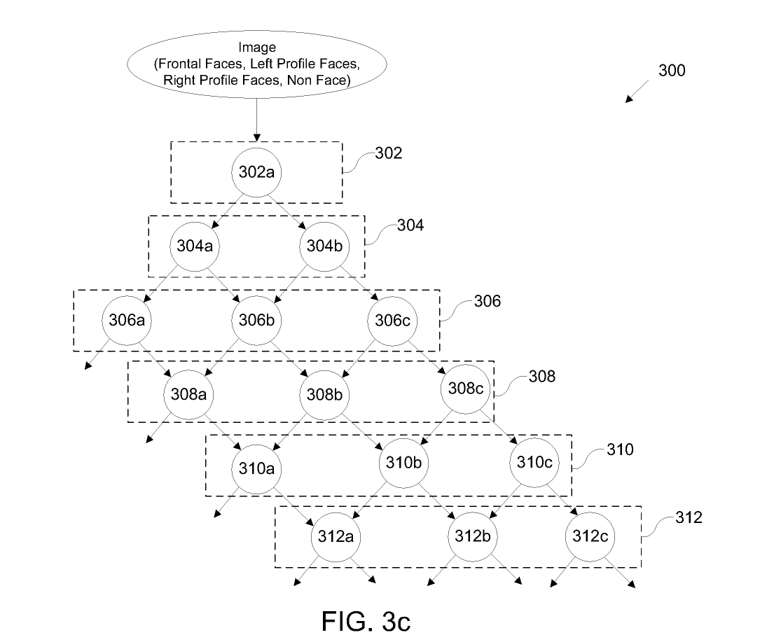

Referring now to FIG. 3a, a net cascade object classification structure 300 is shown, in accordance with another embodiment of the present invention. Net cascade object classification structure 300 includes a plurality of nodes such as nodes 302a, 304a-304b, 306a-306c, 308a-308c, 310a-310c, and 312a-312c arranged in a plurality of layers such as layers 302, 304, 306, 308, 310, and 312 respectively. Each layer includes at least one parent node and each subsequent layer includes at least two child nodes. For example, while working at layer 302 of net cascade object classification structure 300, node 302a represents a parent node and operatively linked nodes 304a and 304b in the corresponding subsequent layer represent child nodes. However, while working at layer 304, node 304a and 304b represent parent nodes and operatively linked nodes 306a, 306b, and 306c in the corresponding subsequent layer represent child nodes. Further, at least one child node in the subsequent layers is operatively linked to two or more parent nodes in the preceding layer. For example, as depicted in FIG. 3a, nodes 306b, 308b, 310b, and 312b are operatively linked to two parent nodes in the preceding layers 304, 306, 308, and 310 respectively. Each node of the plurality of nodes includes one or more classifiers (not shown). The working of net cascade object classification structure 300 is similar to pyramid cascade object classification structure 200, as explained above with reference to FIG. 2.

Referring now to FIG. 3b, a schematic diagram illustrating the training of net cascade object classification structure 300 for classifying multi-view faces is shown, in accordance with an exemplary embodiment of the present invention. The training of net cascade object classification structure 300 is performed on a layer-by-layer basis. In accordance with an embodiment of the present invention, the classifiers of the nodes have a detection rate of around 99.5% and false positive rate of around 50%. As known in the art, the detection rate gives an estimation of the number of faces detected correctly by the classifiers; whereas the false positive rate indicates the false detection of the non-faces as faces i.e., those regions which are not faces but are falsely detected as faces. However, it may be appreciated by a person skilled in the art, that the detection rate and the false positive rate of the classifiers may vary based on the required efficiency, image processing complexity or computation power. As depicted in FIG. 3b, the training of nodes 302a, 304a, and 306a proceeds based on the input data. In accordance with an embodiment of the present invention, the input data includes frontal view faces, left profile faces, right profile faces, and non-face images. Further, the training of the nodes 304b, 306c, 308c, 310c, and 312c proceeds based on the output provided by one parent node in the corresponding preceding layer, i.e., nodes 302a, 304b, 306c, 308c, and 310c respectively. Furthermore, the training of the nodes 306b, 308a, 308b, 310a, 310b, 312a, and 312b proceeds based on the output provided by two parent node in the corresponding preceding layer, i.e., nodes 304a-304b, 306a-306b, 306b-306c, 308a-308b, 308b-308c, 310a-310b, and 310b-310c respectively.

As illustrated in FIG. 3b, nodes 302a, 304b, 306c, 308c, 310c, and 312c are primarily trained with the frontal view faces. Further, the training of these nodes may also depend on the output provided by only one parent node in the preceding layer. Hence, the positive training samples for these nodes are the frontal view faces and the negative training samples are the non-face images that are provided in the beginning at node 302a. Nodes 304a, 306b, 308b, 310b, and 312b are primarily trained with the left profile faces and nodes 306a, 308a, 310a, and 312a are primarily trained with the right profile faces. Additionally, the training of these nodes may also depend on the output provided by two parent nodes in the preceding layer. Hence, the positive training samples for these nodes are the left profile faces and the right profile faces, respectively, with various amounts of rotation and tilt; whereas the negative training samples are the negative training samples that are rejected by one of the parent node and the negative training samples that are falsely detected as the positive training samples by the other parent node. For example, in case of node 308b, the positive training samples are the left profile faces; whereas the negative training samples are the ones rejected by parent node 306c and the samples that are falsely detected as left profile faces by parent node 306b. Hence, the negative training samples that are used for training any node in net cascade object classification structure 300 is based on the output provided by the parent nodes.

Referring now to FIG. 3c, a schematic diagram illustrating the classification of the multi-view faces in the image using net cascade object classification structure 300 is shown, in accordance with an exemplary embodiment of the present invention. The features associated with the one or more objects from the image are determined and the classifiers of node 302a evaluate the objects based on the computed feature information stored in the look up table. Subsequently, around 99.5% of the objects relating to the frontal view faces are correctly classified and around 50% of the objects relating to the negative non-face images are falsely classified as positive objects and are passed to node 304b; whereas the remaining 50% of the objects relating to the negative non-face images are classified as negative objects and are rejected to node 304a. Node 304a further classifies the negative objects received from node 302a. Thereafter, about 99.5% of the objects relating to the left profile faces and about 50% of the objects relating to the negative non-face images are falsely classified as positive objects and are passed to node 306b; whereas the remaining 50% of the objects relating to the negative non-face images are classified as negative objects and are rejected to node 306a. Similarly, node 304b further classifies the positive objects received from node 302a. Approximately 99.5% of the objects relating to the frontal view faces and 50% of the objects relating to the negative non-face images are falsely classified as positive objects and are passed to node 306c; whereas the remaining 50% of the objects relating to the negative non-face images are classified as negative objects and are rejected to node 306b. Hence, the objects rejected at one node are further evaluated by another node in the subsequent layer, thereby increasing the detection rate without increasing computational complexity.

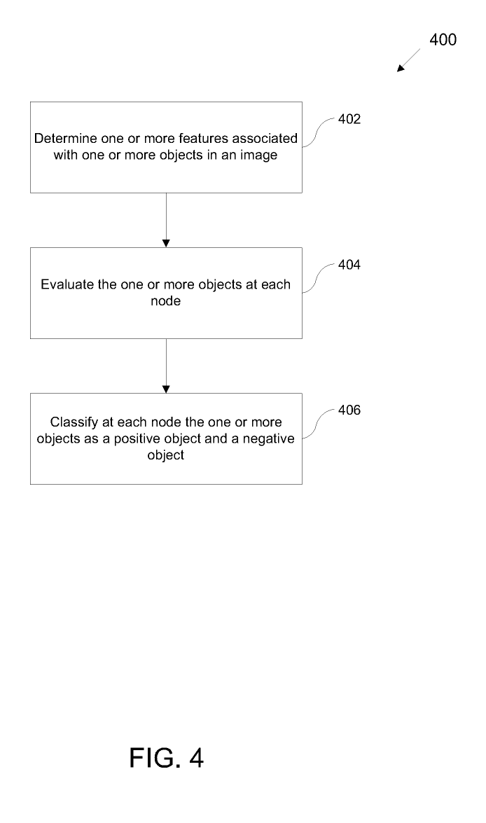

Referring now to FIG. 4, a flow chart depicting a method 400 for classifying one or more objects in an image is shown, in accordance with an embodiment of the present invention. At step 402, one or more features associated with the one or more objects from the image are determined. In an embodiment, the features determined from the image may correspond to pixel values at a particular co-ordinate (pre-assigned for each node). Initially, the image is scanned at different scales and over each pixel. To scan the image, a working window is placed at different positions in the image in a sequential fashion. Thereafter, the features corresponding to the objects in the image are determined based on the computed feature information stored in the look up table during training phase (discussed above with reference to FIG. 2).

At step 404, the objects are evaluated at each node of a plurality of nodes of the cascade object classification structure (discussed with reference to FIGS. 2 and 3). During evaluation, one or more classifiers relating to each node compares the Haar feature value (stored in the look up table) to a threshold (normalized with respect to the standard deviation of the input image) for determining a positive value or a negative value. For example, if the Haar feature value is below the threshold value, then the threshold function has a negative value, and if the Haar feature value is above the threshold value, then the threshold function has a positive value. The threshold functions are then accumulated as a classifier sum. The threshold functions can be deemed to be the weights given to the particular weak classifier being evaluated. In various embodiments of the present invention, in at least one of the evaluations, the node may receive the evaluated objects from two or more nodes of a preceding layer.

At step 406, at each node, the objects of the image are classified as a positive object and a negative object based on the evaluation. Examples of the objects include, but are not limited to, faces and objects with different orientations in 3-Dimension space. For example, the nodes may classify an object as the positive object if the accumulated sum of the threshold functions are above a given node classifier threshold otherwise the object may get classified as the negative object. The classification of the positive object and the negative object depends on the training provided to the classifiers, as discussed above with reference to FIG. 2. In various embodiments of the present invention, in at least one of the classifications, the positive object and the negative object are further classified in the corresponding subsequent layer.

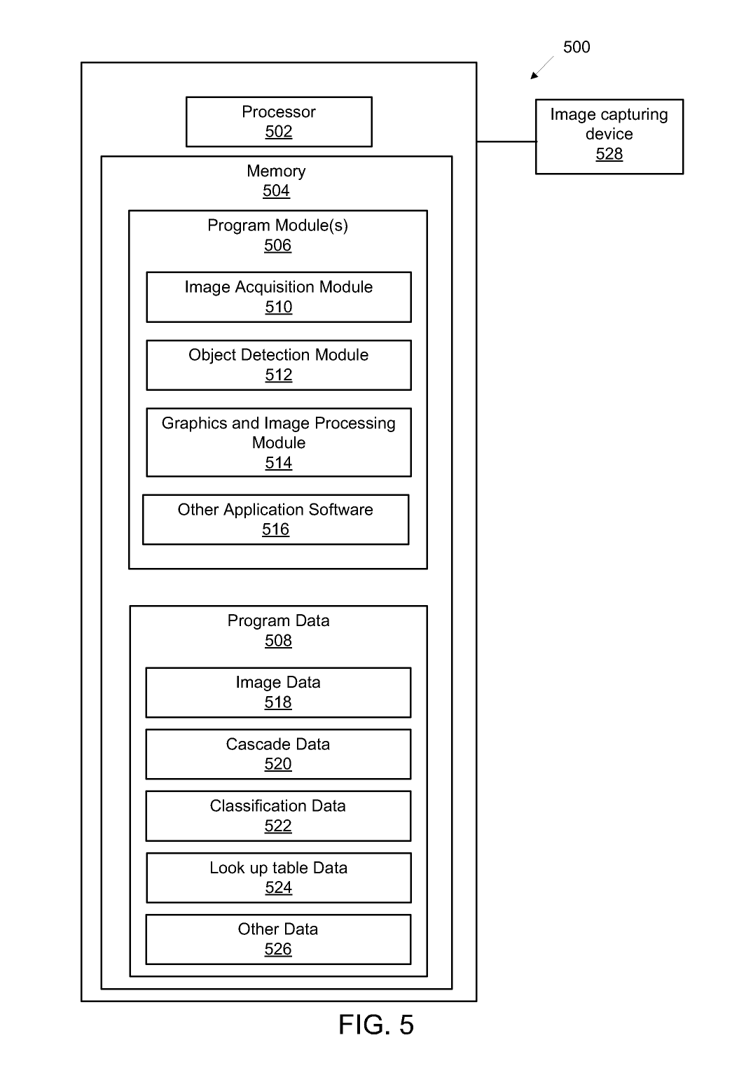

FIG. 5 shows an example of a system 500 that may implement cascade object classification structure as explained above with reference to FIGS. 2 and 3. System 500 may be a desktop PC, laptop, and a hand held device such as a personal digital assistant (PDA), a mobile phone, a camcorder, a digital still camera (DSC), and the like. System 500 includes a processor 502 coupled to a memory 504 storing computer executable instructions. Processor 502 accesses memory 504 and executes the instructions stored therein. Memory 504 stores instructions as program module(s) 506 and associated data in program data 508. Program module(s) 506 includes an image acquisition module 510, an object detection module 512, and a graphic and image processing module 514. Program module 506 further includes other application software 516 required for the functioning of system 500.

Program data 508 stores all static and dynamic data for processing by the processor in accordance with the one or more program modules. In particular, program data 508 includes image data 518 to store information representing image characteristics and statistical data, for example, DCT coefficients, absolute mean values of the DCT coefficients, etc. The program data 508 also stores a cascade data 520, a classification data 522, a look up table data 524, and other data 526. Although, only selected modules and blocks have been illustrated in FIG. 5, it may be appreciated that other relevant modules for image processing and rendering may be included in system 500. System 500 is associated with an image capturing device 528, which in practical applications may be in-built in system 500. Image capturing device 528 may also be external to system 500 and may be a digital camera, a CCD (Charge Coupled Devices) based camera, a handy cam, a camcorder, and the like.

Having described a general system 500 with respect to FIG. 5, it will be understood that this environment is only one of countless hardware and software architectures in which the principles of the present invention may be employed. As previously stated, the principles of the present invention are not intended to be limited to any particular environment.

In operation, image acquisition module 510 involves image capturing device 528 to captures an image. System 500 receives the captured image and stores the information representing image characteristics and statistical data in image data 518. Object detection module 512 generates a cascade object classification structure, as discussed above with reference to FIGS. 2 and 3 and stores the structure in cascade data 520. Subsequently, object detection module 512 fetches the image characteristics from image data 518 and computed feature information (stored during training phase) from look up table data 524 and determines one or more features associated with one or more objects of the image. Examples of the features include, but are not limited to, DCT features, Wavelet transformed features, and Haar features.

Thereafter, object detection module 512 executes one or more evaluation operations on the objects (based on the computed feature information stored in look up table data 524) at each node of the cascade object classification structure. In succession, object detection module 512 executes one or more classification operations of the evaluated objects at each node of the cascade object classification structure. Such classification operations result in the one or more objects in the image being classified as a positive object and a negative object. Object detection module 512 stores the classified objects in classification data 522. Thereafter, object detection module 512 detects the classified objects as faces and objects with different orientations in 3-Dimension space. Object detection module 512 stores the detected objects in other data 524.

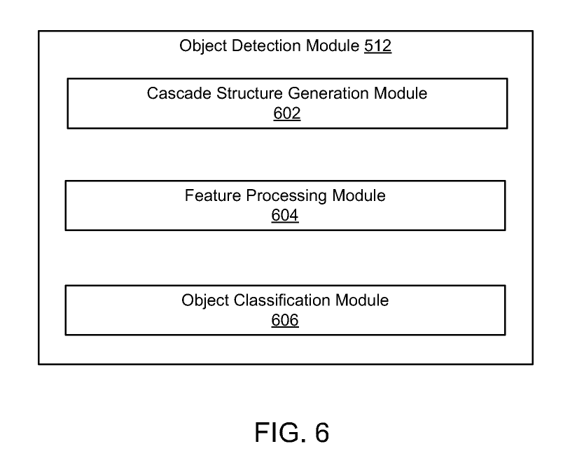

FIG. 6 illustrates an example implementation of object detection module 512 as discussed above with reference to FIG. 5, in accordance with an embodiment of the present invention. Object detection module 512 includes a cascade structure generation module 602, a feature processing module 604, and an object classification module 606. Cascade structure generation module 602 generates the cascade object classification structure. The cascade object classification structure includes a plurality of nodes arranged in one or more layers as discussed earlier in relation to FIGS. 2 and 3. The number of layers in the structure as generated by cascade structure generation module 602 depends at least in part on a desirable object detection rate and image processing complexity associated with system 500. For example, the number of layers may lie in the range of 6 to 15 but are not limited to these numbers. The structure having 6 layers may provide a good detection rate with very less computational complexity; whereas the structure having 15 layers may provide very high detection rate with a minimal increase in complexity. Further, in various embodiments of the present invention, cascade structure generation module 602 generates the structure such that at least one node of the plurality of nodes is operatively linked to two or more nodes in a preceding layer. In addition, cascade structure generation module 602 implements one or more classifiers in each of the nodes.

Feature processing module 604 determines and evaluates the one or more objects in the image. It may be appreciated by a person skilled in the art that, existing systems and methods for determination of features and evaluation of objects may be employed for the purposes of ongoing description.

Object classification module 606 executes one or more classifications at each of the nodes of the structure and classifies the one or more objects as a positive object and a negative object. The execution of the classifications depends at least in part on one or more evaluated objects and the corresponding location of each of the nodes in the cascade object classification structure. Each of the positive objects and the negative objects as classified by the nodes in each layer, using object classification module 606, are further classified by one or more operatively linked nodes in the corresponding subsequent layer.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data, which cause a general-purpose computer, special purpose computer, or special purpose-processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A cascade object classification structure implemented in a computing device for classifying one or more objects in an image, the cascade object classification structure comprising:
a plurality of nodes arranged in one or more layers, each layer having at least one parent node and each subsequent layer having at least two child nodes such that:
at least one child node in at least one of the subsequent layers is operatively linked to two or more parent nodes in a preceding layer, each node comprising one or more classifiers for classifying the one or more objects as one of a positive object and a negative object, and
at least one of the positive objects or/and the negative objects as classified by the at least one parent node in each layer are further classified by one or more operatively linked child nodes in the corresponding subsequent layer.

2. The cascade object classification structure according to claim 1, wherein the one or more objects corresponds to at least one of: a face image and an object image with different orientations in 3-Dimension space.

3. The cascade object classification structure according to claim 1, wherein the plurality of nodes in the one or more layers are arranged in the form of a pyramid, and wherein the number of nodes in a layer is proportional to the hierarchy level of the layer in the pyramid.

4. The cascade object classification structure according to claim 1, wherein the plurality of nodes in the one or more layers are arranged in the form of a net structure.

5. The cascade object classification structure according to claim 1, wherein each node is configured to pass the positive objects and to reject the negative objects.

6. The cascade object classification structure according to claim 1, wherein each of the plurality of nodes is trained based at least in part on a corresponding location in the structure.

7. The cascade object classification structure according to claim 1, wherein the one or more classifiers are configured to detect either similar or different type of the one or more objects.

8. The cascade object classification structure according to claim 1, wherein the number of the layers in the cascade object classification structure lies in the range of 6 to 15.

9. A method for classifying one or more objects in an image, the method comprising:
determining one or more features associated with the one or more objects from the image;
evaluating the one or more objects at each node of a plurality of nodes, wherein the plurality of nodes are arranged in one or more layers, at least one of the one or more evaluations comprises receiving the evaluated objects from two or more nodes of a preceding layer; and
classifying at each node, based at least in part on the evaluation, the one or more objects as one of a positive object and a negative object such that at least one of the one or more classifications comprises further classifying the positive object and the negative object in the subsequent layer.

10. The method according to claim 9 further comprising training each of the plurality of nodes based at least in part on: an input data, an output provided by at least one node of the preceding layer and the location of each of the plurality of nodes in the one or more layers.

11. The method according to claim 10, wherein the input data comprises at least one of face samples and object samples with different orientations in 3-Dimension space.

12. The method according to claim 10, wherein the input data is either similar or different.

13. The method according to claim 10, wherein the training is performed on a layer-by-layer basis.

14. The method according to claim 9 further comprising:
passing the positive objects; and
rejecting the negative objects from each of the plurality of nodes.

15. The method according to claim 9, wherein the one or more features corresponds to at least one of features associated with a face and an object with different orientations in 3-Dimension space.

16. The method according to claim 9, wherein the one or more features is selected from a group comprising: DCT features, wavelet transformed features, and Haar features.

17. A system for detection of one or more objects in an image, the system comprising:
an image acquisition module configured to direct an image capturing device to acquire the image; and
an object detection module configured to detect the one or more objects based at least in part on a classification performed by a cascade object classification structure, the structure comprising a plurality of nodes arranged in one or more layers, each layer having at least one parent node and each subsequent layer having at least two child nodes such that at least one child node in at least one of the subsequent layers is operatively linked to two or more parent nodes in a preceding layer, wherein each node have one or more classifiers for classifying the one or more objects as one of a positive object and a negative object, and at least one of the of the positive objects and/or the negative objects as classified by the at least one parent node in each layer are further classified by one or more operatively linked child nodes in the corresponding subsequent layer.

18. The system as claimed in claim 17, wherein the object detection module comprises a cascade structure generation module configured to generate the cascade object classification structure based at least in part on a desirable object detection rate and image processing complexity associated with the system.

19. The system as claimed in claim 17, wherein the object detection module comprises a feature processing module configured to determine one or more features and evaluate the one or more objects in the image.

20. The system as claimed in claim 19, wherein the object detection module comprises an object classification module configured to execute one or more classifications at each of the nodes based at least in part on the one or more evaluated objects and the corresponding location of each of the nodes.
